(19) United States
(12) Patent Application Publication
(10) Pub. No.: US 2021/0324251 A1
(43) Pub. Date: Oct. 21, 2021

(54) A FOAM COMPOSITION AND A FOAM COMPOSITE MADE THEREFROM

(71) Applicant: Dow Global Technologies LLC, Midland, MI (US)

(72) Inventor: Adebola O. Ogunniyi, Missouri City, TX (US)

(21) Appl. No.: 17/258,921

(22) PCT Filed: Jul. 11, 2019
(86) PCT No.: PCT/US2019/041367

§ 371 Date: Jan. 8, 2021

Related U.S. Application Data
(60) Provisional application No. 62/701,998, filed on Jul. 23, 2018.

(51) Int. Cl. C09J 175/08; C08J 9/14; C08G 18/76; C08G 18/71; C08G 18/42; C08G 18/48; C08G 18/40; C09J 5/08; B32B 5/18; B32B 15/04; B32B 15/095

(52) U.S. Cl. CPC C09J 175/08; B32B 2266/0278; C08G 18/7671; C08G 18/718; C08G 18/4208; C08G 18/4829; C08G 18/4018; C09J 5/08; B32B 5/18; B32B 15/046; B32B 15/095; C08J 2205/10; C08J 2201/022; C08J 2375/08; C08J 2203/142; C09J 2475/00; B32B 2250/40; C08J 9/146

(57) ABSTRACT

A rigid foam-forming composition including (a) at least one isocyanate component; (b) at least one polyol component; (c) at least one blowing agent; (d) at least one catalyst; (e) at least one surfactant; and (f) at least one silane component. The foam-forming composition provides a foam having an increased adhesion when the foam is adhered to a substrate. The foam-forming composition can be particularly suitable for fabricating a panel structure including a foam core disposed in between a first and second facing material.

### FIELD

The present invention relates to a foam-forming composition and a foam composite made from such foam-forming composition.

### BACKGROUND

Known panel systems are typically a composite made of a core of rigid foam material, such as a rigid foam, sandwiched between two substrates (e.g. metals such as aluminum, steel, or foil; paper; plastic; composites; and the like). The substrates of the panel are generally referred to as the facing (or facer) materials. Heretofore, known rigid foam-forming formulations used for preparing panel systems (continuous or discontinuous) have been known to exhibit issues with durability because of poor or insufficient adhesion between the core rigid foam and the facing (or facer) materials.

It would be desirable to provide a foam-forming composition (or formulation or system) for producing a foam that can be formulated in situ in a one-step process and that can have an increased adhesion to a facer material of a composite product.

### SUMMARY

The present invention is directed to a rigid foam formulation of a single combination of all components that make up the foam-forming formulation. In one embodiment, the present invention includes a rigid foam formulation useful for preparing the core foam of panels. The foam-forming formulation exhibits an improved facer adhesion property which can be achieved by including a silane additive in the A-side of the foam-forming formulation. The present invention includes the selection of the silane additive and the incorporation of the silane additive into the A-side of the formulation to improve the adhesion of the foam core to facer materials of a composite product. In one preferred embodiment, the silane additive can be for example an isocyanatosilane compound.

In one general embodiment, the rigid foam-forming composition of the present invention includes: (a) at least one isocyanate component; (b) at least one polyol component; (c) at least one blowing agent; (d) at least one catalyst; (e) at least one surfactant; and (f) at least one silane component. Advantageously, the foam-forming composition having a silane component (f) is useful for providing a foam having an increased adhesion (as measured by the method of ASTM D-1623) of at least greater than (>) 10 percent (%) compared to a foam provided by a foam-forming composition without the silane component (f).

Another embodiment of the present invention includes a process for making the above foam-forming composition.

Still another embodiment of the present invention includes a composite article such as panel comprising, for example, two shell panels (e.g., metal panels) and a foam core disposed between the two shell panels wherein the core foam is made from the above foam-forming composition with an increased adherence to the two shell panels.

### DETAILED DESCRIPTION

Foam-forming formulations are advantageously used to produce polyurethane rigid (PUR) foams and polyisocyanurate rigid (PIR) foams. Generally, the foams are made by reacting a reactive foam-forming composition, formulation or system which includes the reaction of a polyisocyanate component (a) comprising one or more polyisocyanate compounds with a polyol component (b) comprising one or more polyol compounds. Preferably, the reaction is carried out in the presence of (c) one or more blowing agents and (d) one or more catalysts such as described in U.S. Pat. No. 7,714,030. When the above components (a)-(d) are mixed and reacted, the reaction forms a foam.

The foam system of the present invention includes a foam-forming composition to prepare a rigid foam such as a PUR foam or a PIR foam. In the present invention, the foam-forming reactive composition includes the incorporation of a silane additive, as component (f) for increased adhesion of the foam product with one or more substrates. The silane additive in the formulation increases the adhesion between the foam core made from the foam-forming composition or formulation and facer materials of a composite product. For example, in one preferred embodiment, the silane additive can be an isocyanatosilane compound.

The PUR or PIR foam-forming composition or formulation of the present invention includes at least one isocyanate component, as component (a) of the formulation, i.e., the isocyanate component useful in the present invention may include one or more isocyanate-containing components. The polyisocyanate component, component (a), useful for preparing the foam-forming composition may include for example a single polyisocyanate compound or a mixture of two or more different polyisocyanate compounds; and the isocyanate component (a) compounds are adapted for reacting with the polyol component (b).

In general, suitable polyisocyanate compounds useful in the polyisocyanate component (a) of the present invention can include aromatic, aliphatic and cycloaliphatic polyisocyanates. For example, the polyisocyanate component, component (a), useful for preparing the rigid foam-forming composition may include one or more polyisocyanate compounds or isocyanate-terminated prepolymers such as m-phenylene diisocyanate; 2,4- and/or 2,6-toluene diisocyanate (TDI); the various isomers of diphenylmethane diisocyanate (MDI); the so-called polymeric MDI products; carbodiimide modified MDI products; hexamethylene-1,6-diisocyanate; tetramethylene-1,4-diisocyanate; cyclohexane-1,4-diisocyanate; hexahydrotoluene diisocyanate; hydrogenated MDI; naphthylene-1,5-diisocyanate; and mixtures thereof.

The polyisocyanate component (a) can have an average functionality of isocyanate groups of, for example, greater than or equal to (>) 2.3 in one embodiment, >2.7 in another embodiment, and from 2.5 to 4.0 in still another embodiment.

Generally, the amount of polyisocyanate component (a) used in the foam-forming formulation of the present invention can have an isocyanate index of generally for example from 100 to 800. By “isocyanate index”, it is meant a ratio of equivalents of isocyanate groups to the active hydrogen atoms in the reaction mixture, multiplied by 100. Said in another way, the isocyanate index is the molar equivalent of isocyanate (NCO) groups divided by the total molar equivalent of isocyanate-reactive hydrogen atoms present in a formulation, multiplied by 100. As would be understood by a person of ordinary skill in the art, the isocyanate groups may be provided through the at least one isocyanate component, and the active hydrogen atoms may be provided through the at least one polyol component.

When preparing a PUR foam, the isocyanate index can be from 100 to 180 in one embodiment and from 110 to 140 in another embodiment. When preparing a PIR foam, the isocyanate index can be from 200 to 800 in one embodiment and from 200 to 600 in another embodiment. Alternatively, the polyisocyanate component may represent from 30 weight percent (wt %) to 90 wt % of the overall foam formulation, and preferably from 40 wt % to 80 wt %.

The polyol component, component (b), useful for preparing the foam-forming composition may include for example a single polyol compound or a mixture of two or more different polyol compounds. For example, the polyol component, component (b), useful for preparing the foam-forming composition may include one or more polyol compounds known in the art such as alkylene glycols such as ethylene glycol, propylene glycol, 1,4-butane diol, 1,6-hexanediol and the like, and mixtures thereof; glycol ethers such as diethylene glycol, triethylene glycol, and the like, and mixtures thereof; tertiary amine-containing polyols; polyether polyols; aromatic polyester polyols; and mixtures thereof. Also useful for the polyol component, may include a polyester polyol/polyether polyol blend. Examples of polyesters useful for the blend may include TEROL® 256, Stepan® 2352, Terate® 2031, and mixtures thereof. Examples of polyethers useful for the blend may include VORANOL™ 360, VORANOL™ 2070, VORANOL™ RN-482, and mixtures thereof.

The functionality (average number of isocyanate-reactive groups/molecule) of the polyol component can be, for example, from 2 to 8 in one embodiment. Generally, the hydroxyl equivalent weight (HEW) of the foam-forming formulation can be, for example, less than (<) 600 in one embodiment, <400 in another embodiment, and <250 in still another embodiment. In yet other embodiments, the HEW of the formulation can be from 10 to <600. The polyol could represent from 10 wt % to 70 wt % of the overall foam formulation, and preferably from 20 wt % to 60 wt %.

A variety of conventional blowing agents can be used as component (c) in the present invention. The blowing agent, component (c), useful for preparing the foam-forming composition may include for example a single blowing agent compound or a mixture of two or more different blowing agent compounds. For example, the blowing agent, component (c), useful for preparing the foam-forming composition may include one or more of water, various hydrocarbons, various hydrofluorocarbons, various chlorofluorocarbons, various fluorocarbons, various chlorocarbons, various hydrohaloolefins (such as hydrofluorolefins and hydrochlorofluroolefins), various esters, various ethers, various ketones, various aldehydes, a variety of chemical blowing agents that produce nitrogen or carbon dioxide under the conditions of the foaming reaction, and the like; and mixtures thereof. In one preferred embodiment, water can be used as the blowing agent.

The blowing agent, component (c), may be added to the polyisocyanate component (a) or to the polyol component (b), or to both components (a) and (b). In one preferred embodiment, for example, the blowing agent is added to the polyol component. The weight percentage amount of the blowing agent, component (c), used in the foam-forming formulation of the present invention may range generally from 0.01 wt % to 20 wt % in the polyol component side in one embodiment and from 5 wt % to 10 wt % in the polyol component side in another embodiment. Alternatively, the blowing agent could represent from 0.01 wt % to 15 wt % of the overall foam formulation, and preferably from 1 wt % to 10 wt %.

A variety of known catalysts can be used as component (d) in the present invention. The catalyst, component (d), useful for preparing the foam-forming composition may include for example a single catalyst compound or a mixture of two or more different catalyst compounds. For example, the catalyst useful in the present invention may include tertiary amines such as trimethylamine, triethylamine, N-methylmorpholine, N-ethylmorpholine, N,N-dimethylbenzylamine, N,N-dimethylethanolamine, N,N,N′,N′-tetramethyl-1,4-butanediamine, N,N-dimethylpiperazine, bis(dimethylaminoethyl) ether and triethylenediamine; tertiary phosphines such as trialkylphosphines and dialkylbenzylphosphines; various alkali metal carboxylates such as potassium octoate, potassium acetate, potassium pivalate and the like; and mixtures thereof. In still another embodiment, tertiary amine catalysts such as N,N,N-trimethyl-N-hydroxyethyl-bis(aminoethyl) ether, dimethyl 1-2(2-aminoethoxy) ethanol and the like; and mixtures thereof, can also be used in the present invention.

The catalyst, component (d), may be mixed with the other components of the foam-forming composition; and in one preferred embodiment, for example, the catalyst can be added to the polyol component. The weight percentage amount of catalyst, component (d), used in the foam formulation may range generally from 0.01 wt % to 10 wt % in the polyol component side in one embodiment and from 0.5 wt % to 2.5 wt % in the polyol component side in another embodiment. Alternatively, the catalyst may represent from 0.001 wt % to 5 wt % of the overall foam formulation, and preferably from 0.01 wt % to 3 wt %.

The surfactant, component (e), useful for preparing the foam-forming composition may include for example a single surfactant compound or a mixture of two or more different surfactant compounds. Surfactants are beneficial as compounds that serve to aid the homogenization of the starting materials and may also be suitable for regulating the cell structure of the foam. Surfactants, including silicone-based surfactants and organic surfactants, may be added to serve as cell stabilizers.

Some representative silicone-based surfactants materials useful in the present invention may include, for example, polysiloxane polyoxylalkylene block copolymers and silicone polyether (SPE) surfactant. Some representative organic surfactants materials useful in the present invention may include, for example, organic surfactants containing polyoxyethylene-polyoxybutylene block copolymers. Other surfactants useful in the present invention include polyethylene glycol ethers of long-chain alcohols, tertiary amine or alkanolamine salts of long-chain allyl acid sulfate esters, alkylsulfonic esters, alkyl arylsulfonic acids, and combinations thereof. In another embodiment, an organic surfactant such as VORASURF™ 504 available from The Dow Chemical Company, can be used in the present invention.

In one embodiment, the surfactant component (e) can be incorporated into the B-side of the foam-forming formulation (i.e., to the polyol component (b)); and the concentration of the surfactant additive can be for example from 0.01 wt % to 5 wt % in one embodiment, from 0.1 wt % to 3 wt % in another embodiment, and from 0.5 wt % to 2 wt % in still another embodiment based on the total components in the foam-forming composition.

The silane additive, as component (f), useful for preparing the foam-forming composition may include for example a single silane compound or a mixture of two or more different silane compounds. The desired silane may be defined as a species with a central silicon (Si) atom covalently linked (or adjacent) to at least one alkoxy group and at least one isocyanate-functionalized moiety, as represented in the following structure:

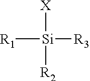

where in the above structure, R₁ is an alkoxy group, and the molecule can have 1 to 3 such groups of varying size/length (e.g., C₁-C₁₂); R₂ is an alkyl group or hydrogen, and the molecule can have 0 to 2 such groups of varying size/length (e.g., C₁-C₁₂); R₃ is an isocyanate-terminated/functionalized moiety, and the molecule can have 1 to 3 such groups of varying size/length (e.g., C₀-C₁₂); and X is any other species that is not isocyanate-reactive.

For example, the silane component, component (f), useful for preparing the foam-forming composition may include one or more silane compounds known in the art such as γ-isocyanatopropyltriethoxysilane or γ-isocyanatopropyltrimethoxysilane; and mixtures thereof. In one preferred embodiment, the silane, component (f), may be added to the polyisocyanate component (a).

In one embodiment, the silane component (f) can be incorporated into the A-side of the foam-forming formulation; and the concentration of the silane additive can be for example >0.01 wt % in the polyisocyanate component of the formulation, from 0.02 wt % to 5 wt % in another embodiment, and from 0.05 wt % to 1 wt % in still another embodiment. Alternatively, the silane can represent from 0.001 wt % to 5 wt % of the overall foam formulation in one embodiment, and from 0.01 wt % to 1 wt % in another embodiment.

A variety of other optional conventional components can be added to the polyisocyanate component (a) and/or the polyol component (b) to form the foam system. Suitable optional compounds or additives useful for the foam system are well known in the art and can include, for example, other co-catalysts, toughening agents, flow modifiers, dyes, diluents, stabilizers, plasticizers, catalyst de-activators, flame retardants, liquid nucleating agents, solid nucleating agents, Ostwald ripening retardation additives, and mixtures thereof. In one preferred embodiment, the composition of the present invention can include one or more fire retardants.

Any suitable combination of the above optional additives and additive amounts, as well as the method of incorporating the optional additive(s) into the foam-forming composition can be carried out. Typically, each of the above optional additives, if used in the foam composition, does not exceed 15 wt % based on total composition weight. The optional additives may be advantageously used in the range of generally from 0 wt % to 15 wt % in one embodiment; and from 0.001 wt % to 10 wt % in another embodiment.

As one illustration of the present invention foam-forming composition, the composition includes: (a) at least one isocyanate component having an average functionality of isocyanate groups of from 2.5 to 4.0; (b) at least one polyol component having a hydroxyl equivalent weight of less than 600; (c) at least one blowing agent present in the composition at a concentration of from 0.01 wt % to 20 wt % in the polyol component side of the composition; (d) at least one catalyst at a concentration of from 0.01 wt % to 5 wt % in the polyol component side of the composition; (e) at least one surfactant at a concentration of from 0.01 wt % to 5 wt % in the polyol component side of the composition; and (f) at least one silane component at a concentration of from greater than 0.01 wt % to 5 wt % in the polyisocyanate component side of the composition.

In one broad embodiment, the process for making the reactive foam composition of the present invention includes admixing components (a) to (f) as described above in a single combination of components generally in a one-pot process to form the foam composition. Alternatively, the preparation of the foam composition includes providing at least one polyisocyanate component (a) which can also be referred to herein as the “A-side” of the foam composition; and providing at least one polyol component (b) which can also be referred to herein as the “B-side” of the foam composition.

In one embodiment, the blowing agent component (c), and the silane component (f) may be added to the A-side of the foam formulation; and the blowing agent component (c), the catalyst component (d), the surfactant component (e), and any of the optional additives may be added to the B-side of the foam formulation.

In preparing the foam composition, the A-side and the B-side are separately and individually prepared, as described above, with the ingredients (a)-(f) and other optional ingredients, if any; and all of the components can be mixed together in the desired concentrations discussed above to prepare the foam composition. In one preferred embodiment, the A-side can be a premixture of at least one isocyanate component and at least one silane component to form the premixture; and the B-side can be a premixture of at least one polyol component, at least one blowing agent, at least one catalyst, and at least one surfactant. The premixing of the ingredients to form the A-side can be carried out, for example, by combining the different components in-line through a static mixer or in a vessel at ambient conditions with mixing by recirculation or with an impeller. Similarly, the premixing of the ingredients to form the B-side can be carried out, for example, by combining the different components in-line through a static mixer or in a vessel at ambient conditions with mixing by recirculation or with an impeller.

Once the premixtures of the A-side and the B-side are formed as described above, the mixing of the components, via the A-side and the B-side, can be carried out at a temperature of from 65° F. to 100° F. (18° C. to 38° C.) in one embodiment; and from 70° F. to 95° F. (21° C. to 35° C.) in another embodiment. The ingredients that make up the foam composition may be mixed together by any known mixing process and equipment. For example, the polyisocyanate component premix (A-side) and the polyol premix (B-side) can be mixed together by any known urethane foaming equipment. In a broad embodiment, a process for making the rigid foam includes admixing and reacting components (a) and (b) as introduced by way of an A-side and a B-side wherein the A-side and/or the B-side can include components (c)-(f) and any number of other optional components or additives as described above.

To manufacture the rigid foam, the A-side can be mixed with the B-side by impingement mixing or passing the two fluid components through a static mixer, at preferably ambient temperature and at the desired ratio, forming the reactive formulation. The resulting reactive blend is then subjected to conditions, such as an elevated temperature, sufficient to allow the foaming reaction to occur to form a foam. Generally, the reactive foam-forming formulation can be injected or poured into a mold cavity containing a shell or sheet of facer material followed by a subsequent heating of the formulation in the mold at a predetermined temperature and for a desirable amount of time to cure the foam.

For example, the foam-forming formulation, once the components are combined together in intimate contact with each other, via the mixture of the A-side and B-side, can be heated at a temperature of from 85° F. to 140° F. (29° C. to 60° C.) in one embodiment; from 95° F. to 130° F. (35° C. to 54° C.) in another embodiment; and from 105° F. to 125° F. (40° C. to 52° C.) in still another embodiment. Skilled artisans may adapt the reaction kinetics of the present invention to achieve a best mold filling and foaming for the most economical manufacturing.

The foam produced in accordance with the present invention has certain advantageous properties and benefits. For example, a foam made with the addition of a silane component (f) to a foam-forming formulation can exhibit an increase of adhesion to a facer material of 1.5 times to 2 times greater than a foam made without the addition of silane component (f) to a foam-forming formulation. In one general embodiment, the foam-forming composition having a silane component (f) provides a foam having an increased adhesion of, for example, at least greater than 10 percent compared to a foam-forming composition not having a silane component (f). In another embodiment, the foam-forming composition having a silane component (f) provides a foam having an increased adhesion of, for example, at least greater than 50 percent compared to a foam-forming composition not having a silane component (f). The increased adhesion percentage may be measured by the method of ASTM D-1623.

Other properties of the foam can be measured by a number of property tests to provide an indication of increased adhesion including, for example, the tensile bond strength of the foam and facer material measured at a test speed of 0.05 inches/minute (in/min) (0.02 millimeter/second (mm/s)) according to the procedure described in ASTM D-1623; and the strain load on the foam-facer assembly, the break load of the foam-facer assembly, and the compressive strength of the foam as determined according to the method described in ASTM D-1621. For example, in a general embodiment, the tensile bond strength of the foam can be >10 pounds per square inch (psi) or >69 kilopascal (kPa); the strain load of the foam can be >10 percent (%); the break load of the foam can be >200 pounds force (lb_{f}) or >890 newton (N); and the compressive strength of the foam can be >15 psi or >103.4 kPa.

In general, the rigid foam produced by the formulation of the present invention includes a foam having a core density, as determined according to ASTM D-1622, of from 1.5 pounds per cubic feet (pcf) to 3.5 pcf (24.0 kilograms per cubic meter (kg/m³) to 56 kg/m³) in one embodiment, from 1.8 pcf to 2.5 pcf (28.8 kg/m³ to 40.0 kg/m³) in another embodiment, and from 2.0 pcf to 2.3 pcf (32.0 kg/m³ to 36.8 kg/m³) in still another embodiment.

The Index of the foam can be generally from 100 to 800 in one embodiment and from 100 to 180 or 200 to 600 in another embodiment.

As aforementioned, the panel composite articles of the present invention are manufactured by providing a core of PUR or PIR foam sandwiched between two facer materials. Any of the well-known batch or continuous processes and ancillary equipment can be used for forming a foam composite article. For example, the foam core can be produced from the foam-forming formulation of the present invention by pouring the formulation into a mold cavity which contains facer materials followed by a subsequent curing of the formulation in a heated mold with the facer materials. In one embodiment, the process of making a panel structure generally includes the steps of, for example, placing the facer materials into a mold, pouring a foam-forming composition into the mold, closing the mold and then allowing the rising and reacting of the foam-forming composition to fill the mold in contact with the facer materials allowing the creation of a composite structure. In another embodiment, a composite can be prepared by injecting a foaming mixture into a preassembled mold with a facer material attached. In still another embodiment, a composite can be prepared by dispensing a foaming mixture between two layers of facer materials, a first layer of facer material and a second layer of facer material, on a continuous lamination machine. Other conventional molding techniques known in the art for manufacturing foam composite products can also be used.

The facer materials useful in the present invention can be substrate materials for example metals such as aluminum, steel, or foil; paper; plastic; composites; and the like; or a combination thereof. In one preferred embodiment, the composite may include a foam core sandwiched between a first facer material and a second facer material wherein the first facing material is an aluminum substrate and the second facing material is also an aluminum substrate.

In one preferred embodiment, the method of the present invention for making a panel composite structure includes the steps of: (I) providing a mold with a facer material disposed in the mold; (II) providing a foam-forming reactive mixture; (III) pouring the foam-forming reactive mixture into the mold to contact the facer material structures; (IV) allowing the foam-forming reactive mixture to react for a predetermined period of time and under conditions to form a foam core composite structure inside the mold; and (V) removing the resulting composite structure from the mold.

The foaming mixture can be prepared by impingement mixing of the A-side and the B-side streams, and at a liquid pressure of >1,000 psi (6.9 MPa), preferably >1,200 psi (8.3 MPa) and more preferably >1,500 psi (>10.3 MPa). The liquid temperatures can range from 65° F. to 90° F. (18° C. to 32° C.) in one embodiment, and from 70° F. to 85° F. (21° C. to 29° C.) in another embodiment. The amount of material required can depend on a target density and volume of cavity to be filled which are parameters that those skilled in the art can readily determine.

The composite products made in accordance with the present invention can be useful in a variety of applications including, for example, for producing interior and exterior wall panels, walk-in-cooler assemblies, and the like.

### EXAMPLES

The following examples are presented to further illustrate the present invention in detail but are not to be construed as limiting the scope of the claims. Unless otherwise stated all parts and percentages are by weight.

Various raw materials (ingredients or components) used in the Inventive Examples (Inv. Ex.) and the Comparative Examples (Comp. Ex.) which follow are described herein below in Table I.

TABLE I
Raw Materials

| INGREDIENT | DESCRIPTION | SUPPLIER |
|---|---|---|
| TEROL ™ 256 | modified aromatic polyester polyol with a functionality of | Huntsman |
| | around 2.3 and a hydroxyl number of around 265 mg | |
| | KOH/g | |
| VORANOL ™ 360 | 4.5 functional polyether polyol with a hydroxyl | The Dow |
| | number of around 360 mg KOH/g | Chemical |
| | | Company |
| | | (Dow) |
| DABCO ™ BL-11 | 70% bis(2-dimethylaminoethyl) ether diluted | Evonik |
| | with 30% dipropylene glycol | |
| Triethylamine | triethylamine | Sigma Aldrich |
| Pel-Cat 9540A | 70% solution of potassium octoate diluted | Ele |
| | with 30% diethylene glycol | Corporation |
| Tris (1-chloro-2-propyl) | flame retardant | ICL-IP |
| phosphate (TCPP) | | |
| Dow Corning | silicone surfactant | Dow |
| 193 Additive | | |
| HFC-245fa | 1,1,1,3,3-pentafluoropropane: blowing agent | Honeywell |
| PAPI ™ 27 | polymeric MDI with a functionality of around 2.7 | Dow |
| | and an isocyanate content of around 31.4 wt % | |
| Silquest ™ A-Link 35 | 3-isocyanatopropyltrimethoxysilane | Momentive |
| XIAMETER ™ | isobutyl trimethoxy silane | Dow |
| OFS-2306 | | |

### General Procedure for Preparing Formulation and Adhesion Test Measurements

To demonstrate improvements in adhesion of rigid foam core to facer materials in a panel composite, A-side and B-side components were first pre-mixed/pre-blended before filling into respective tanks of a high-pressure foaming machine. All of the components were then mixed by impingement at 1,500 psi (10.3 MPa) on a high-pressure foaming machine, with liquids maintained at approximately (˜) 70° F. (˜21° C.) and dispensed into a 40 centimeters (cm)×70 cm×10 cm heated (at a temperature of 125° F. (51.7° C.)) panel mold fitted with an aluminum substrate lining the bottom of the mold. Panels were incubated for 40 minutes (min), then demolded and then left at ambient conditions (about 77° F. (25° C.)) to finish curing.

To test for adhesion, multiple (at least four) sections of foam with aluminum facer were cut from cured panels to a size of 4 inches (10 cm)×4 inches (10 cm)×2 inches (5 cm). Then the tensile bond strength of foam to facer for each of the sections was measured according to the procedure described in ASTM D-1623. The test speed used in the ASTM D-1623 method was 0.05 inches/minute (0.02 millimeter/second). Tensile bond strength, strain and break loads of measurement for each formulation tested are shown below in Table II. Compressive strengths were determined according to the method described in ASTM D-1621.

TABLE II
Formulations

| | Comp. | | | | |
|---|---|---|---|---|---|
| | Ex. A | Inv. | Comp. | Comp. | Comp. |
| COMPONENTS | (Control) | Ex. 1 | Ex. B | Ex. C | Ex. D |
| B-Side Components | | | | | |
| TEROL ™ 256 | 85.10 | 85.10 | 85.10 | 85.10 | 85.10 |
| VORANOL ™ 360 | 14.90 | 14.90 | 14.90 | 14.90 | 14.90 |
| Dabco ™ BL-11 | 0.22 | 0.22 | 0.22 | 0.22 | 0.22 |
| Triethylamine | 0.22 | 0.22 | 0.22 | 0.22 | 0.22 |
| Pel-Cat 9540A | 0.49 | 0.49 | 0.49 | 0.49 | 0.49 |
| TCPP | 17.87 | 17.87 | 17.87 | 17.87 | 17.87 |
| Dow Corning 193 Additive | 4.85 | 4.85 | 4.85 | 4.85 | 4.85 |
| HFC-245fa | 20.21 | 20.21 | 20.21 | 20.21 | 20.21 |
| Water | 3.57 | 3.57 | 3.57 | 3.57 | 3.57 |
| A-Side Components | | | | | |
| PAPI ™ 27 | 165.650 | 163.994 | 163.994 | 165.634 | 165.648 |
| Silquest ™ A-Link 35 | 0.000 | 1.656 | 0.000 | 0.000 | 0.000 |
| XIAMETER ™ OFS-2306 | 0.000 | 0.000 | 1.656 | 0.016 | 0.002 |
| Total | 313.08 | 313.08 | 313.08 | 313.08 | 313.08 |
| Index | 138 | 138 | 138 | 138 | 138 |
| RESULTS | | | | | |
| Gel Time, s | 96 | 99 | 100 | 98 | 96 |
| Tack-Free Time, s | 152 | 161 | 147 | 135 | 135 |
| Core Density, pcf (kg/m³) | 2.141 | 2.212 | 2.192 | 2.127 | 2.143 |
| | (34.3) | (35.4) | (35.1) | (34.1) | (34.3) |
| Compressive Strength, | 19.8 | 23.2 | 19.7 | 24 | 24.7 |
| psi (kPa) | (136.5) | (160.0) | (135.8) | (165.5) | (170.3) |
| Tensile Bond strength, | 6.34 | 14.01 | 8.12 | 9.59 | 10.15 |
| psi (kPa) | (43.7) | (96.9) | (56.0) | (66.1) | (70.0) |
| Strain, % | 3.13 | 6.73 | 5.70 | 4.65 | 5.37 |
| Break Load, lb_{f} (N) | 94.87 | 223.71 | 118.99 | 151.29 | 146.98 |
| | (422) | (995) | (529) | (673) | (654) |

Notes for Table II:
The amounts of the formulations described in Table II are in units of “pphp” (parts per one hundred parts polyol).

1. A rigid foam-forming composition comprising:
(a) at least one isocyanate component;
(b) at least one polyol component;
(c) at least one blowing agent;
(d) at least one catalyst;
(e) at least one surfactant; and
(f) at least one silane component.

2. The composition of claim 1, wherein the at least one isocyanate component and the at least one silane component are premixed.

3. The composition of claim 1, wherein the foam-forming composition having a silane component (f) provides a foam having an increased adhesion of at least greater than 10 percent compared to a foam provided by a foam-forming composition without the silane component (f) as measured by the method of ASTM D-1623.

4. The composition of claim 1, wherein the at least one silane component is a species with a central silicon (Si) atom covalently linked (or adjacent) to at least one alkoxy group and at least one isocyanate-functionalized moiety, as represented in the following structure: 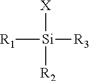
where in the above structure, R₁ is an alkoxy group, and the molecule has from 1 to 3 of such groups having C₁-C₁₂ carbon atoms; R₂ is an alkyl group or hydrogen, and the molecule has from 0 to 2 of such groups having C₁-C₁₂ carbon atoms; R₃ is an isocyanate-terminated/functionalized moiety, and the molecule has from 1 to 3 of such groups having C₀-C₁₂ carbon atoms; and X is a non-isocyanate-reactive species.

5. The composition of claim 1, wherein the at least one silane component is γ-isocyanatopropyltriethoxysilane; γ-isocyanatopropyltrimethoxysilane; or a mixture thereof.

6. The foam-forming composition of claim 1, wherein (a) the at least one isocyanate component has average functionality of isocyanate groups of from 2.5 to 4.0; (b) the at least one polyol component has a hydroxyl equivalent weight of less than 600; (c) the concentration of the at least one blowing agent present in the composition is from 0.01 weight percent to 20 weight percent in the polyol component side of the composition; (d) the concentration of the at least one catalyst is from 0.01 weight percent to 5 weight percent in the polyol component side of the composition; (e) the concentration of the at least one surfactant is from 0.01 weight percent to 5 weight percent in the polyol component side of the composition; and (f) the concentration of the at least one silane component is from greater than 0.01 weight percent to 5 weight percent of the polyisocyanate component side.

7. A rigid foam article comprising the reaction product of the rigid foam-forming composition as claimed in claim 1.

8. A composite panel structure comprising:
(a) a first facing material;
(b) a second facing material; and
(c) a rigid foam in contact with at least a portion of the surface of the first and second facing material; wherein the rigid foam is sandwiched between the first and second facing material; and wherein the rigid foam comprises the reaction product of the rigid foam-forming composition as claimed in claim 1.

9. The composite structure of claim 8, wherein the first facing material is a metal substrate; and wherein the second facing material is a metal substrate.

10. A method of making a rigid foam panel composite structure comprising the steps of:
(I) providing a first facing material;
(II) providing a second facing material; and
(III) applying the rigid foam-forming composition as claimed in claim 1 to at least a portion of the surface of the first and second facing material; wherein the rigid foam-forming composition is applied in between the first and second facing material such that a foam core is formed sandwiched between the first and second facing material.

11. A method of forming the rigid foam-forming composition as claimed in claim 1, comprising (i) mixing the at least one isocyanate component and the at least one silane component to form a premixture, and (ii) adding to the premixture the at least one polyol component, the at least one blowing agent, the at least one catalyst, and the at least one surfactant.
